(19) United States
(12) Patent Application Publication
(10) Pub. No.: US 2009/0309082 A1
(43) Pub. Date: Dec. 17, 2009

(54) Fan Cooled Winch

(75) Inventors: Eric J. Webb, Vancouver, WA (US); Bryan M. Averill, Portland, OR (US); Bryon M. Borntrager, West Linn, OR (US); Steven W. Shuyler, Clackamas, OR (US)

Correspondence Address: HARNESS, DICKEY & PIERCE, P.L.C., P.O. BOX 828, BLOOMFIELD HILLS, MI, 48303, US

(73) Assignee: Warn Industries, Inc., Milwaukie, OR (US)

(21) Appl. No.: 12/137,131

(22) Filed: Jun. 11, 2008

(51) Int. Cl. B66D 1/36; B66D 1/08

(52) U.S. Cl. 254/340; 254/361

(57) ABSTRACT

A winch may include a drum, a winch motor adapted to rotatably drive the drum in a first direction and a second direction, a cable adapted to be wound off of and onto the drum, and a fan including an impeller selectively driven by a fan motor. The fan is adapted to cool the winch motor.

### FIELD

The present disclosure relates to a winch and in particular to a fan cooled winch.

### BACKGROUND

The statements in this section merely provide background information related to the present disclosure and may not constitute prior art.

Winches are often mounted to a support bracket at the front bumper location of a vehicle, and can be used to perform a variety of tasks, such as dragging a large object while the vehicle is stationary, or moving the vehicle itself by attaching the free end of the winch cable to a stationary object and reeling in the cable to pull the vehicle toward that object. Winches typically include a cable winding drum supported on each end and an electric or hydraulic motor in combination with a speed reducing gear transmission for transmitting torque to the cable winding drum. The use of winches with off-road and utility vehicles has greatly enhanced the functionality of the vehicles.

Operation of the winch causes the motor to heat up. Overheating may damage the motor. Accordingly, there is a need in the art for an effective means of cooling the winch motor.

### SUMMARY

In one form, a winch may include a drum, a winch motor adapted to rotatably drive the drum in a first direction and a second direction, a cable adapted to be wound off of and onto the drum, and a fan including an impeller selectively driven by a fan motor. The fan is adapted to cool the winch motor.

In another form, a winch may include a drum, a winch motor adapted to rotatably drive the drum in a first direction and a second direction, a cable adapted to be wound off of and onto the drum, a fan including an impeller adapted to be driven by a fan motor, a first duct having a first end fluidly connected to the fan and a second end connected to the winch motor, and a second duct having a first end fluidly connected to the winch motor and a second free end.

In yet another form, a winch may include a drum, a winch motor adapted to rotatably drive the drum in a first direction and a second direction, a cable adapted to be wound off of and onto the drum, a fan including an impeller selectively driven by a fan motor, and a means for selectively actuating the fan motor independently of the winch motor. The fan may draw air through a remotely located opening of an intake pipe and force the air at least partially around the winch motor and exhaust the air through an exhaust pipe, thereby cooling the winch motor.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a fan cooled winch mounted to a vehicle according to the principles of the present disclosure;

FIG. 2 is a cross sectional schematic view of the fan cooled winch of FIG. 1;

FIG. 3 is a schematic illustration of a control system of the fan cooled winch having a micro controller according to the principles of the present disclosure;

FIG. 4 is a schematic illustration of the control system of the fan cooled winch having a thermal switch according to the principles of the present disclosure;

FIG. 5 is a schematic illustration of the control system of the fan cooled winch having a manual on-off switch according to the principles of the present disclosure; and

FIG. 6 is a cross sectional schematic view of a fan cooled winch according to the principles of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

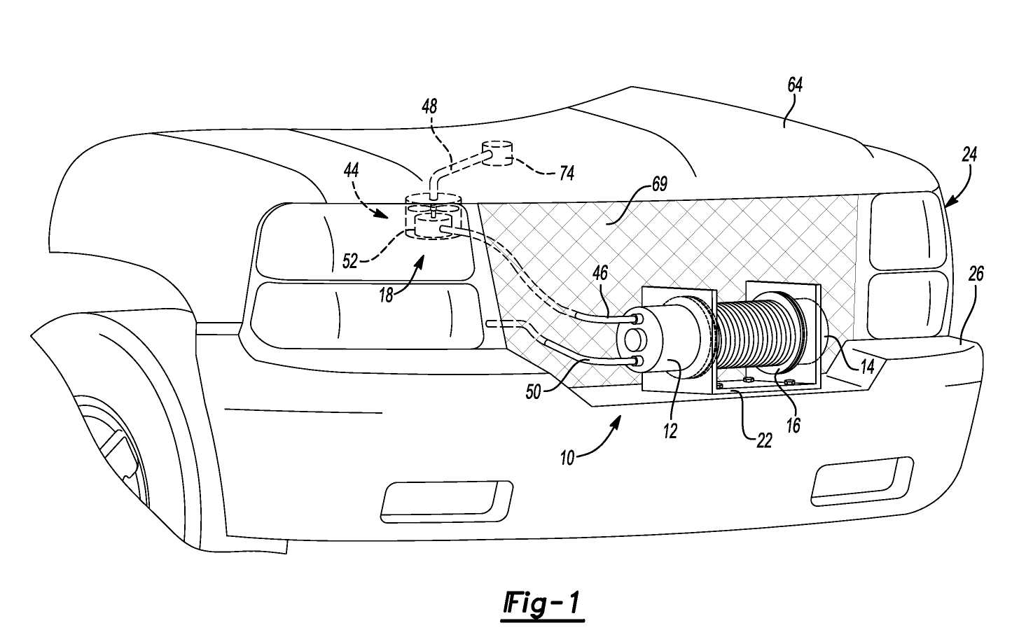

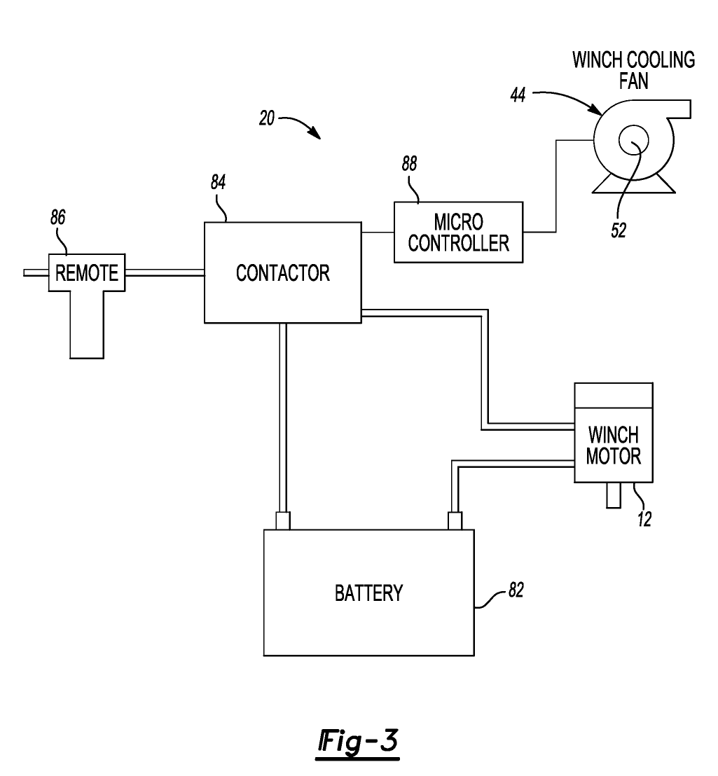

With reference to FIGS. 1-6, a winch 10 is provided and includes a winch motor 12, a gearbox 14, a cable winding drum 16, a cooling system 18, and a control system 20 (FIGS. 3-5). The cooling system 18 forces air across at least a portion of the winch motor 12, thereby cooling the winch motor 12. The winch 10 may include a support 22 which can be mounted to a suitable location of a vehicle 24, such as, for example, a front bumper 26, as shown in FIG. 1. It should be appreciated that the winch 10 is not limited to vehicle-mounted winches. The winch 10 can be mounted to any suitable structure or the winch 10 can be free-standing.

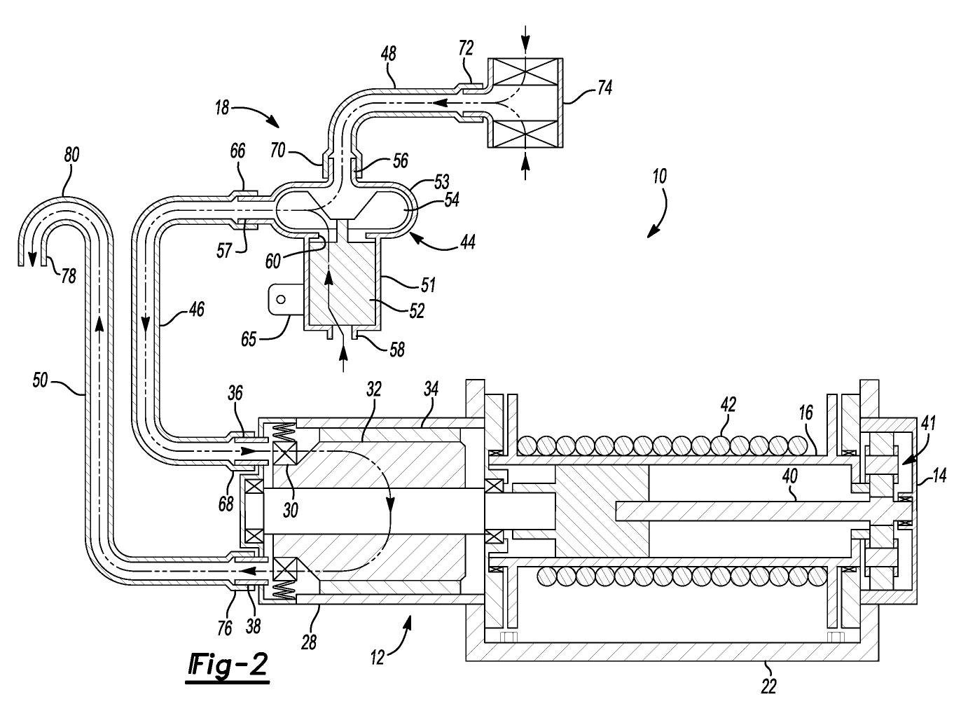

Referring now to FIG. 2, the winch motor 12 may include a winch motor housing 28 encasing brushes 30, an armature 32, and a field coil 34. It should be appreciated that the winch motor 12 may be any suitable source of rotary motive power, such as a combustion engine or a motor having a permanent magnet. The winch motor housing 28 may include a cool air inlet 36 and a hot air outlet 38. The cool air inlet 36 and the hot air outlet 38 are in fluid communication with the cooling system 18.

Upon receiving electric current, the winch motor 12 drives a driveshaft 40 meshingly engaging a reduction gear system 41 disposed within the gearbox 14. The reduction gear system 41 transfers torque from the driveshaft 40 to the cable winding drum 16. An operator can selectively actuate the winch motor 12 to rotate the cable winding drum 16 in a first direction and a second direction to wind a cable 42 onto the cable winding drum 16 and unwind the cable 42 off of the cable winding drum 16, respectively. Although the winch motor 12 is shown in the figures as being an electric motor, it should be appreciated that the winch motor 12 could be a hydraulic motor, an internal combustion engine, or any other source of rotary motive power.

The cooling system 18 may include a fan 44, a cooling pipe 46, an intake pipe 48, and an exhaust pipe 50. The fan 44 may include a fan motor housing 51 encasing a fan motor 52 and an impeller housing 53 encasing an impeller 54. The impeller housing 53 may include an inlet 56 and an outlet 57.

The fan motor housing 51 may include a fan motor inlet 58, and an aperture 60. An air filter could be disposed on the fan motor inlet 58 to prevent contaminants from contacting the fan motor 52. The aperture 60 allows fluid communication between the fan motor housing 51 and the impeller housing 53.

The fan 44 may be disposed under a hood 64 of the vehicle 24 (FIG. 1), for example, or any other location that may protect the fan 44 from moisture, debris and other contaminants to which the cable winding drum 16 may be exposed. The fan 44 can include a base or mounting bracket 65 (FIG. 2) to facilitate its mounting to a desired vehicle location. It should be appreciated that the fan 44 could be disposed outside of the vehicle 24 proximate the front bumper 26, for example.

The cooling pipe 46 may be a flexible tube including a first end 66 and a second end 68. The first end 66 may be fluidly engaged with the outlet 57 of the impeller housing 53. The cooling pipe 46 may extend from the impeller housing 53 under the hood 64 of the vehicle 24, through a grille 69 of the vehicle 24 (FIG. 1) to the winch motor 12, where the second end 68 of the cooling pipe 46 may be fluidly engaged with the cool air inlet 36 of the winch motor 12. Since the fan 44 may be disposed in any suitable location under the hood 64 or outside of the vehicle 24, the cooling pipe 46 may be any suitable length to interconnect the winch motor 12 and the fan 44.

The intake pipe 48 may be a flexible pipe including a first end 70 and a second end 72. The intake pipe 48 may be fluidly connected to the inlet 56 of the impeller housing 53 at the first end 70 such that the impeller 54 may draw air through the intake pipe 48 and forces the air into the cooling pipe 46. The intake pipe 48 may be any appropriate length and may extend from the fan 44 generally away from the cable winding drum 16 and the winch motor 12, such that air drawn into the intake pipe 48 is free from heat, moisture, debris and other contaminants. The intake pipe 48 may extend away from the grille 69 of the vehicle 24 such that the second end 72 is disposed under the hood 64. The second end 72 could alternatively be disposed outside of the vehicle 24 and extend upward along a frame of a passenger compartment of the vehicle 24, for example, or any other suitable location where the second end 72 can be prevented from being submerged in water or exposed to dirt and dust. An air filter 74 may be disposed on the second end 72 of the intake pipe 48 to further prevent the impeller from drawing contaminants into the cooling system 18.

The exhaust pipe 50 may be a flexible pipe including an inlet portion 76 and an outlet portion 78. The inlet portion 76 may fluidly engage the hot air outlet 38 of the winch motor housing 28. The exhaust pipe 50 may extend from the hot air outlet 38 through the grille 69 of the vehicle 24 to a suitable location under the hood 64 of the vehicle 24. It should be appreciated that the exhaust pipe 50 could alternatively extend from the hot air outlet 38 along the outside of the vehicle 24 to any suitable location where heated air from within the winch motor housing 28 may be exhausted. The exhaust pipe 50 may include a generally U-shaped portion 80 disposed proximate the outlet portion 78 so that the outlet portion faces downward to prevent debris from falling into the exhaust pipe 50.

With reference to FIG. 3, the control system 20 may include a battery 82, a contactor 84, a remote control unit 86, and a micro controller 88. The battery 82 may provide power to one or both of the fan motor 52 and the winch motor 12. The battery 82 could be mounted in any suitable location on the winch 10 or in the vehicle 24. The battery 82 could be any suitable battery known in the art to power the winch motor 12 and the fan motor 52.

The remote control unit 86 allows an operator to remotely control the operation of the winch motor 12 to wind the cable 42 onto and off of the cable winding drum 16. The remote control unit 86 may also allow the operator to manually turn the fan motor 52 on and off. The remote control unit 86 may be electrically connected to the control system 20 via a cord having a sufficient length to allow the operator to stand clear of the winch 10 and the vehicle 24 during operation of the winch 10. Alternatively, the remote control unit 86 may be a wireless unit adapted to communicate with the control system 20 via radio, infrared or any other wireless signal.

The micro controller 88 allows electrical current to reach the fan motor 52 as needed to actuate the cooling system 18. The micro controller 88 may actuate the fan motor 52 based on one or more predetermined operating conditions of the winch motor 12. For example, the predetermined operating conditions may include a predetermined duration of a run time of the winch motor 12, a predetermined total elapsed run time of the winch motor 12 over a predetermined amount of time, a predetermined operating speed of the winch motor 12, a predetermined load on the winch motor 12, and/or a predetermined temperature of the winch motor 12.

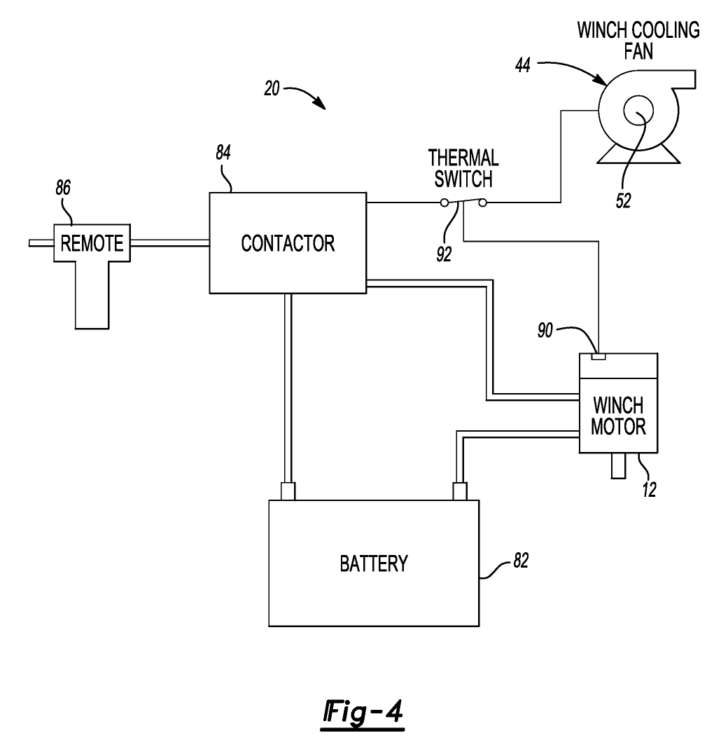

Referring now to FIG. 4, the control system 20 may additionally or alternatively include a temperature sensor 90 disposed on or proximate to the winch motor 12. The temperature sensor 90 may be in communication with a thermal switch 92. The thermal switch 92 may allow electrical current to reach the fan motor 52 in response to the temperature sensor 90 sensing a predetermined temperature of the winch motor 12. The thermal switch 92 may open to prevent electrical current from reaching the fan motor 52 when the temperature falls below the predetermined temperature.

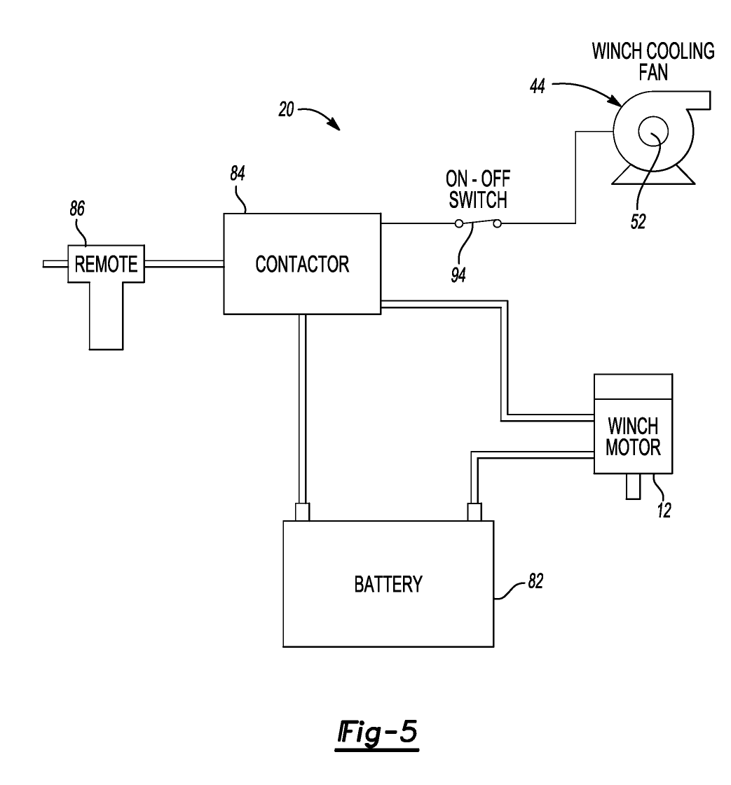

Referring now to FIG. 5, the cooling system 20 may additionally or alternatively include a manual on-off switch 94. The operator may manually actuate the manual on-off switch 94 to actuate the cooling system 18. The manual on-off switch 94 may be disposed on any suitable location on the vehicle 24, the remote control unit 86, or the winch 10 including the winch motor housing 28 or the gearbox 14, for example. It should be appreciated that the control system 20 may include any or all of the micro controller 88, the temperature sensor 90, the thermal switch 92, and the manual on-off switch 94 to control the operation of the cooling system 18.

With reference to FIGS. 1-5, the operation of the winch 10 will be described in detail. As described above, an operator may actuate the winch motor 12 via the remote control unit 86. Electrical current flowing through the brushes 30, the armature 32, the field coil 34 and/or any other components of the winch motor 12 creates heat in the winch motor 12. To prevent the winch motor 12 from overheating, the control system 20 causes the cooling system 18 to cool the winch motor 12.

Upon receiving electrical current from the battery 82, the fan motor 52 causes the impeller 54 to rotate within the impeller housing 53. Rotation of the impeller 54 causes air to be drawn in through the intake pipe 48 and into the impeller housing 53 (FIG. 2). Air may be simultaneously drawn in through the fan motor inlet 58, through the fan motor housing 51 and into the impeller housing 53 (FIG. 2). As the air is drawn through the fan motor housing 51, the air flows around at least a portion of the fan motor 52, thereby cooling the fan motor 52.

The air drawn into the impeller housing 53 from the intake pipe 48 and the fan motor inlet 58 is subsequently forced into the cooling pipe 46 air from impeller housing 53 through the cooling pipe 46. The air flows through the cooling pipe 46 and into the cool air inlet 36 of the winch motor 12. From the cool air inlet 36, the air may flow around at least a portion of the winch motor 12 including, for example, the brushes 30, the armature 32, and/or the field coils 34, thereby cooling the winch motor 12 as the flow of cool air removes heat therefrom. The heated air then flows out of the hot air outlet 38 and into the exhaust pipe 50. The heated air flows through the exhaust pipe 50 and exits through the outlet portion 78 into the environment.

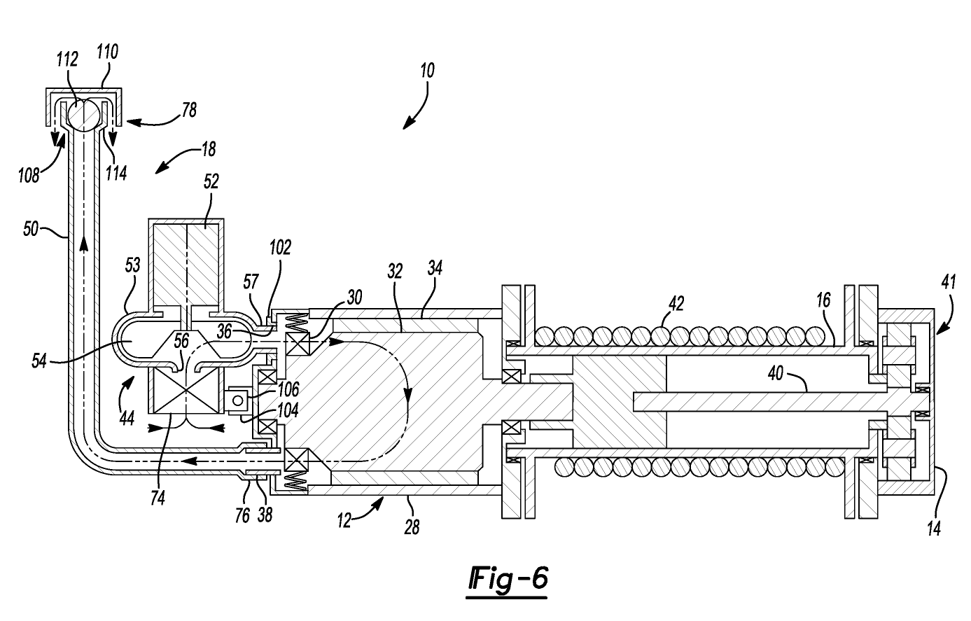

With reference to FIG. 6, the winch 10 is shown having various alternative and/or additional features and configurations. For example, the fan 44 may be mounted to or integrally formed with the winch motor 12. It should be noted that even in this configuration, the fan 44 may be powered by the fan motor 52, which may be operated independently of the winch motor 12.

In the particular embodiment shown in FIG. 6, the outlet 57 of the fan 44 is engaged with the cool air inlet 36 of the winch motor housing 28. A gasket 102 disposed around the cool air inlet 36 may provide sealed fluid communication between the impeller housing 53 and the winch motor housing 28. The winch motor housing 28 and the fan 44 may include mounting brackets 104, 106, respectively, or any other suitable structure to facilitate mounting the fan 44 to the winch motor 12.

The air filter 74 may be disposed directly over the inlet 56 of the impeller housing 53. In this configuration, the impeller 54 may draw air through the air filter 74 and directly into the impeller housing 53, where the air will be subsequently forced into the winch motor housing 28, as shown in FIG. 6.

The outlet portion 78 of the exhaust pipe 50 may include a check valve 108 and/or a baffle 110 (FIG. 6). The check valve 108 may include a valve member 112 and a valve seat 114 having a generally V-shaped cross section. The valve member 112 may be generally spherical or any other suitable shape to form a seal with the valve seat 114. The baffle 110 may be disposed over the check valve 108. The check valve 108 and baffle 110 may cooperate (or independently function) to prevent water and/or debris from entering the exhaust pipe 50, while allowing hot air to exit therethrough. The check valve 108 and baffle 110 can be any suitable configuration.

It should be appreciated that the winch 10 may include any combination of the features and configurations described above with reference to FIG. 106. The description of the present disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A winch comprising:
a drum;
a winch motor adapted to rotatably drive said drum in a first direction and a second direction;
a cable adapted to be wound off of and onto said drum; and
a fan including an impeller selectively driven by a fan motor,
wherein said fan is adapted to cool said winch motor.

2. The winch according to claim 1, wherein said fan forces air through a cooling air pipe routing air from said fan to said winch motor.

3. The winch according to claim 1, further comprising an exhaust pipe adapted to route heated air away from said winch motor.

4. The winch according to claim 3, wherein said exhaust pipe includes a U-shaped portion.

5. The winch according to claim 3, wherein said exhaust pipe includes a check valve.

6. The winch according to claim 3, wherein a baffle is disposed over the outlet portion of said exhaust pipe.

7. The winch according to claim 1, wherein said fan draws air through an air filter attached to said fan.

8. The winch according to claim 1, wherein said fan draws air through an intake pipe having an air filter disposed thereon.

9. The winch according to claim 1, wherein a fan motor intake port allows said impeller to draw air past said fan motor, thereby cooling said fan motor.

10. The winch according to claim 1, further comprising a thermal switch adapted to allow electric current to power said fan motor in response to a predetermined temperature of said winch motor.

11. The winch according to claim 10, further comprising a temperature sensor in communication with said thermal switch, said temperature sensor is adapted to sense a temperature of said winch motor.

12. The winch according to claim 1, further comprising a controller in communication with said fan motor, said controller actuating said fan motor in response to a predetermined condition of said winch motor.

13. The winch according to claim 12, wherein said predetermined condition of said winch motor is based at least partially on a predetermined temperature of said winch motor.

14. The winch according to claim 12, wherein said predetermined condition of said winch motor is based at least partially on a predetermined run time of said winch motor.

15. The winch according to claim 12, wherein said predetermined condition of said winch motor is based at least partially on an operating speed of said winch motor.

16. The winch according to claim 12, wherein said predetermined condition of said winch motor is based at least partially on an operating load on said winch motor.

17. The winch according to claim 1, further comprising a manually actuated on-off switch operable to selectively allow electrical current to actuate said fan motor.

18. The winch according to claim 1, further comprising a remote control unit selectively operable to remotely actuate said winch motor.

19. The winch according to claim 18, wherein said remote control unit is selectively operable to remotely actuate an on-off switch allowing electrical current to power said fan motor.

20. The winch according to claim 18, wherein said remote control unit is wireless.

21. The winch according to claim 1, wherein a common battery provides electrical current to said winch motor and said fan motor.

22. The winch according to claim 1, further comprising a support adapted to mount the winch to a vehicle.

23. The winch according to claim 1, wherein said fan is disposed under a hood of a vehicle.

24. The winch according to claim 1, wherein said fan is disposed on said winch motor.

25. A fan cooled winch comprising:
a drum;
a winch motor adapted to rotatably drive said drum in a first direction and a second direction;
a cable adapted to be wound off of and onto said drum;
a fan including an impeller driven by a fan motor;
a first duct having a first end fluidly connected to said fan and a second end fluidly connected to said winch motor; and
a second duct having a first end fluidly connected to said winch motor and a second free end.

26. The fan cooled winch according to claim 25, wherein said fan forces air through said first duct causing said air to flow around at least a portion of said winch motor and exhaust through said second duct, thereby cooling said winch motor.

27. The fan cooled winch according to claim 25, wherein said second duct includes a U-shaped portion.

28. The fan cooled winch according to claim 25, wherein said second duct includes a check valve.

29. The fan cooled winch according to claim 25, wherein a baffle is disposed over an outlet portion of the second duct.

30. The fan cooled winch according to claim 25, wherein said fan draws air through an air filter attached to said fan.

31. The fan cooled winch according to claim 25, wherein said fan draws air through an intake pipe having an air filter disposed thereon.

32. The fan cooled winch according to claim 25, wherein a fan motor intake port allows said impeller to draw air past said fan motor, thereby cooling said fan motor.

33. The fan cooled winch according to claim 25, further comprising a thermal switch adapted to allow electric current to power said fan motor in response to a predetermined temperature of said winch motor.

34. The fan cooled winch according to claim 25, further comprising a temperature sensor in communication with said thermal switch, said temperature sensor is adapted to sense a temperature of said winch motor.

35. The fan cooled winch according to claim 25, further comprising a controller in communication with said fan motor, said controller actuating said fan motor in response to a predetermined condition of said winch motor.

36. The fan cooled winch according to claim 35, wherein said predetermined condition of said winch motor is based at least partially on a predetermined temperature of said winch motor.

37. The fan cooled winch according to claim 35, wherein said predetermined condition of said winch motor is based at least partially on a predetermined run time of said winch motor.

38. The fan cooled winch according to claim 35, wherein said predetermined condition of said winch motor is based at least partially on an operating speed of said winch motor.

39. The fan cooled winch according to claim 35, wherein said predetermined condition of said winch motor is based at least partially on an operating load on said winch motor.

40. The fan cooled winch according to claim 25, further comprising a manually actuated on-off switch operable to selectively allow electrical current to actuate said fan motor.

41. The fan cooled winch according to claim 25, further comprising a remote control unit selectively operable to remotely actuate said winch motor.

42. The fan cooled winch according to claim 41, wherein said remote control unit is wireless.

43. The fan cooled winch according to claim 41, wherein said remote control unit is selectively operable to remotely actuate an on-off switch allowing electrical current to power said fan motor.

44. The fan cooled winch according to claim 25, wherein a common battery provides electrical current to said winch motor and said fan motor.

45. The fan cooled winch according to claim 25, further comprising a support adapted to mount the winch to a vehicle.

46. The fan cooled winch according to claim 45, wherein said fan is disposed under a hood of said vehicle.

47. The fan cooled winch according to claim 25, wherein said fan is disposed on said winch motor.

48. A winch comprising:
a drum;
a winch motor adapted to rotatably drive said drum in a first direction and a second direction;
a cable adapted to be wound off of and onto said drum;
a fan including an impeller selectively driven by a fan motor; and
means for selectively actuating said fan motor independently of said winch motor,
wherein said fan forces air through a cooling pipe and at least partially around said winch motor and exhausts said air through an exhaust pipe, thereby cooling said winch motor.

49. The winch according to claim 48, wherein an air filter is disposed over said fan.

50. The winch according to claim 48, wherein said fan draws air through an intake pipe having an air filter disposed thereon.

51. The winch according to claim 48, wherein said exhaust pipe includes a U-shaped portion.

52. The winch according to claim 48, wherein said exhaust pipe includes a check valve.

53. The winch according to claim 48, wherein said exhaust pipe includes a baffle.

54. The winch according to claim 48, wherein said fan includes a fan motor intake port and said fan draws air through said fan motor intake port causing air to flow at least partially around said fan motor.

55. The winch according to claim 48, further comprising a support adapted to mount the winch to a vehicle.

56. The winch according to claim 48, wherein said fan is disposed under a hood of a vehicle.

57. The winch according to claim 48, wherein said fan is disposed on said winch motor.

58. The winch according to claim 48, further comprising a wireless remote control unit.
